(19) United States
(12) Patent Application Publication
(10) Pub. No.: US 2010/0202358 A1
(43) Pub. Date: Aug. 12, 2010

(54) PROCESSING APPARATUS AND TRANSMISSION METHOD THEREOF

(76) Inventors: Yu-Kuen WU, Yun Lin County (TW); Ching-Yang Wang, Hsin Chu City (TW); San-Ho Wei, Hsin Chu County (TW)

Correspondence Address: Muncy, Geissler, Olds & Lowe, PLLC, 4000 Legato Road, Suite 310, FAIRFAX, VA, 22033, US

(21) Appl. No.: 12/702,929

(22) Filed: Feb. 9, 2010

(30) Foreign Application Priority Data
Feb. 12, 2009 (TW) 098104415
Dec. 30, 2009 (TW) 098145714

(51) Int. Cl. H04W 40/00; H04L 12/56; H04J 3/24

(52) U.S. Cl. 370/328; 370/389; 370/474

(57) ABSTRACT

The invention discloses an apparatus and transmission method thereof. The apparatus combines a wired network transmission unit with a wireless network transmission unit. A control unit distributes and controls the packet to achieve the purpose of link aggregation and fail-over function.

### BACKGROUND OF THE INVENTION

(a) Field of the Invention

The invention relates to a processing apparatus and the transmission method thereof, particularly to a network apparatus and the method thereof to integrate the wired and wireless networks to achieve link aggregation and provide fail-over.

(b) Description of the Related Art

In general, a processing apparatus such as a computer is provided with an Ethernet apparatus but the processing apparatus always experiences the insufficient bandwidth problem while doing data transmission. Besides, during data transmission, if the connection of the Ethernet apparatus is cut off, for example, a user carries the processing apparatus to another location or a network line for an online game is carelessly removed, it causes great inconvenience.

### BRIEF SUMMARY OF THE INVENTION

Therefore, in order to solve the above-mentioned problems, one object of the invention is to provide a processing apparatus to combine the bandwidths of an Ethernet network and a wireless network.

One object of the invention is to provide a processing apparatus to provide a high Ethernet transmission speed and stable transmission quality.

One object of the invention is to provide a processing apparatus to provide fail-over for preventing network disconnection.

One object of the invention is to provide a processing apparatus to achieve transmission load balance between the Ethernet network and the wireless network.

One embodiment of the invention provides a processing apparatus, comprising a wired network transmission unit, a wireless network transmission unit, and a control unit. The wired network transmission unit transmits and receives a first packet through a wired means. The wireless network transmission unit transmits and receives a second packet through a wireless means. The control unit couples to the wired network transmission unit and the wireless network transmission unit. The control unit processes and distributes a packet to generate the first packet and the second packet.

One embodiment of the invention provides a processing system, comprising an operating system and a communication apparatus. While the processing system connects to at least one base station, the operating system generates a communication signal and a packet according to a communication protocol. The communication apparatus communicates with the operating system and has the functions of wired and wireless networks. According to the communication signal, the communication apparatus decides to simultaneously transmit the packet through the wired network and the wireless network or decides to select either the wired network or the wireless network to transmit the packet. Since generally the connection speed of the wired network is faster and more stable, the processing system according to one embodiment preferably selects the wired network to transmit the packet.

One embodiment of the invention provides a processing apparatus, comprising a wired network transmission unit, a wireless network transmission unit, and a control unit. The wireless network transmission unit couples the wired network transmission unit. The control unit couples to the wired network transmission unit and the wireless network transmission unit. The control unit processes and distributes a packet to generate a first packet and a second packet. According to a communication signal, the control unit decides to simultaneously transmit the first packet and the second packet through the wired network transmission unit and the wireless network transmission unit or decides to select either the wired network transmission unit or the wireless network transmission unit to transmit the first packet or the second packet.

One embodiment of the invention provides a transmission method, comprising: processing a packet to generate a first packet and a second packet; and providing an inter media driver for deciding how to transmit the first packet and the second packet according to the network state. The inter media driver can transmit the first packet through the wired network and transmit the second packet through the wireless network. When the wired network has transmission failure, the inter media driver transmits the first packet through the wireless network. Or, when the wireless network has transmission failure or the connection success signal of the wired network is detected, the inter media driver transmits the second packet through the wired network.

The processing system, apparatus, and transmission method according to the invention utilize the wired network and the wireless network that are usually simultaneously equipped in a current computer system to combine bandwidths of different media so as to achieve the purpose of providing fail-over and load balance.

### BRIEF DESCRIPTION OF THE DRAWINGS

FIG. 1A shows a schematic diagram illustrating a processing system according to one embodiment of the invention.

FIG. 1B shows a schematic diagram illustrating the control unit shown in FIG. 1A.

FIG. 2 shows a flow chart illustrating the network transmission method according to one embodiment of the invention.

### DETAILED DESCRIPTION OF THE INVENTION

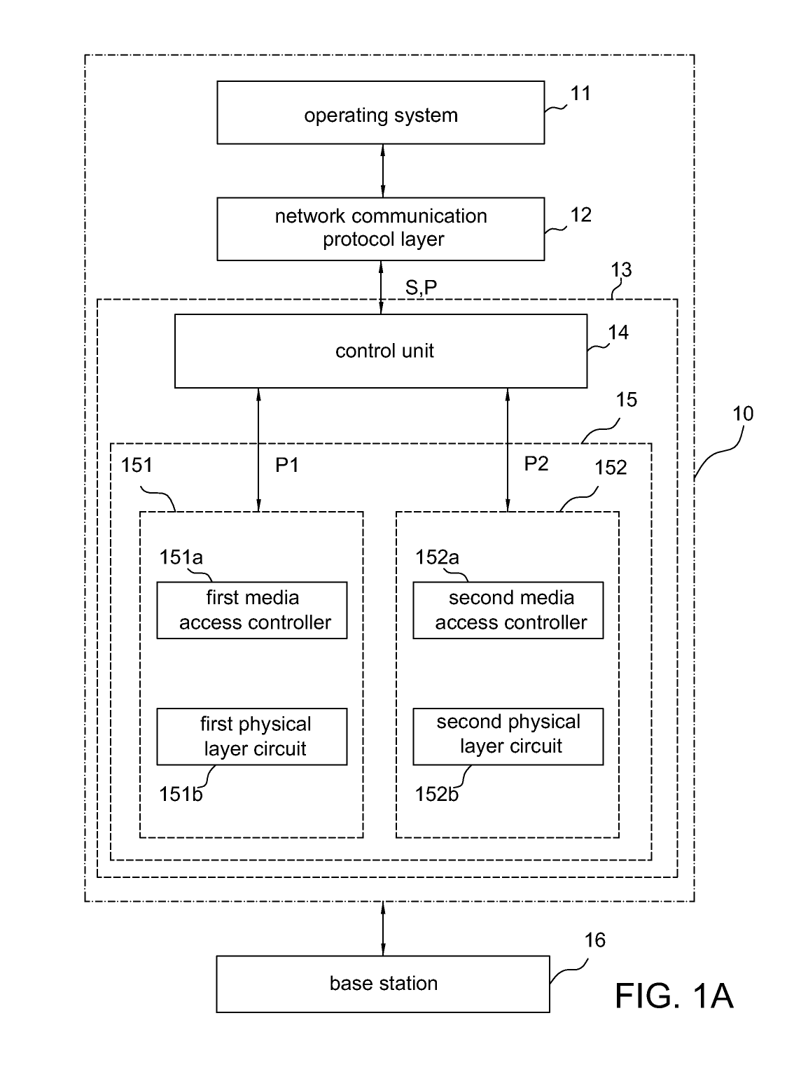

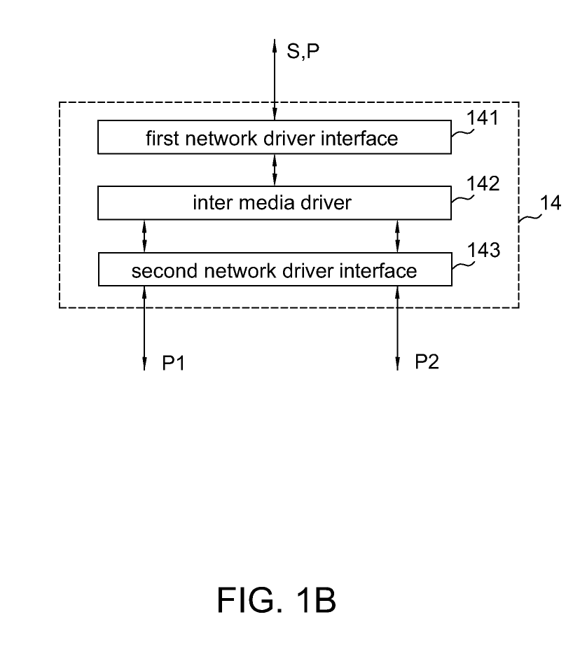

FIG. 1A shows a schematic diagram illustrating a processing system according to one embodiment of the invention. The processing system can be a desktop computer, a laptop computer, any portable electronic device (for example, PDA, internet connectable mobile phone, etc.) or any apparatus supporting wired and wireless networks simultaneously.

As shown in FIG. 1A, the processing system 10 comprises an operating system 11, a network communication protocol layer 12, and a processing apparatus 13. The processing apparatus 13 comprises a control unit 14 and a network apparatus 15. The network apparatus 15 can be built in the processing system 10 or externally connected to the processing system 10 as an external device. The network apparatus 15 comprises a wired network transmission unit 151 and a wireless network transmission unit 152. In one embodiment, the wired network transmission unit 151 can be an Ethernet transmission unit or any current wired transmission unit. The wireless network transmission unit 152 can be a wireless network transmission unit complying with IEEE 802.11 (such as 802.11a/b/g/n) standard or any current wireless transmission unit. The control unit 14 can be an inter media layer. In one embodiment, the control unit 14 complies with Network Driver Interface Specification (NDIS) while in another embodiment the control unit 14 can comply with other interface specification. The control unit 14 couples to the wired network transmission unit 151 and the wireless network transmission unit 152. In one embodiment, as shown in FIG. 1B, the control unit 14 comprises a first network driver interface 141, an inter media driver 142, and a second network driver interface 143. In the embodiment shown in FIG. 1B, the control unit 14 selects the wired network transmission unit 151, the wireless network transmission unit 152, or simultaneously the above two transmission units to achieve network fail-over or network teaming and the inter media driver 142 combines the wired network transmission unit 151 and the wireless network transmission unit 152 and manages receiving and transmitting packets. Please also refer to FIG. 1A. The inter media driver 142 communicates with the operating system 11 through the first network driver interface 141 and communicates with the wired network transmission unit 151 and the wireless network transmission unit 152 through the second network driver interface 143.

As shown in FIG. 1A, the wired network transmission unit 151 comprises a first media access controller 151a and a first physical layer circuit 151b while the wireless network transmission unit 152 comprises a second media access controller 152a and a second physical layer circuit 152b.

Referring to FIG. 1A and FIG. 1B, the following will describe the operation of this embodiment in details.

At first, when the processing system 10 connects to the base station 16, being as the access point (AP), the operating system 11 generates the communication signal S and the packet P and transmits to the processing apparatus 13 through the communication protocol layer 12 according to a communication protocol. In one embodiment, the communication protocol can be one of the following protocols or combination thereof: NetBIOS Extended User Interface (NetBEUI), Internetwork Packet Exchange/Sequenced Packet Exchange (IPX/SPX), Transmission Control Protocol/Internet Protocol (TCP/IP). Then, according to the communication signal S, the control unit 14 controls the wired network transmission unit 151 and the wireless network transmission unit 152 to connect to the base station 16 and later stops using the wired network transmission unit 151 and the wireless network transmission unit 152. The current or future network teaming technique is used to simulate the control unit 14 as a virtual network transmission unit. In addition, the media access control (MAC) addresses of the virtual network transmission unit, the first media access controller 151a, and the second media access controller 152a are set to be the same. After the wired network transmission unit 151, the virtual network transmission unit, and the wireless network transmission unit 152 have the same MAC address, the wired network transmission unit 151, the virtual network transmission unit, and the wireless network transmission unit 152 are initiated. In one embodiment, referring to FIG. 1B, after the virtual network transmission unit simulated by the control unit 14, the wired network transmission unit 151, the wireless network transmission unit 152 have the same MAC address and are reinitiated, the inter media driver 142 becomes the communication bridge between the operating system 11 and the drivers of the wired network transmission unit 151 and the wireless network transmission unit 152. For the two network drivers of the lower layer, the inter media driver 142 is a communication protocol to communicate with the two network drivers. For the operating system 11, the inter media driver 142 is a miniport to communicate with the operating system 11. Thus, the inter media driver 142 is a communication protocol as well as a miniport. In another embodiment, the control unit 14 can be implemented by software, firmware, or hardware.

After the wired network transmission unit 151 and the wireless network transmission unit 152 are initiated, the control unit 14 receives the packet P and processes and distributes the packet P to generate the first packet P1 and the second packet P2. The control unit 14 transmits the packet P through the wired network transmission unit 151, through the wireless network transmission unit 152, or simultaneously through the two media so as to generate the packets P1 and P2. In one embodiment, the first packet P1 complies with wired network transmission format (for example, the transmission format of IEEE 802.3 standard), while the second packet P2 complies with wireless network transmission format (for example, the transmission format of IEEE 802.11 standard).

The inter media driver 142 selects the path of the first packet P1 to transmit the packet P through the first media access controller 151a and the first physical layer circuit 151b via a wired means to the base station 16; or selects the path of the second packet P2 to transmit the packet P through the second media access controller 152a and the second physical layer circuit 152b via a wireless means to the base station 16. Till now, those who are skilled in the art should understand the operating method and principle of transmitting packets from the base station 16 to the processing system 10 and the processing apparatus 13. Thus, its details will not be given hereinafter. The control unit 14 can transmit and receive packets through the wired network transmission unit 151 and the wireless network transmission unit 152 simultaneously to and from the base station 16. Thus, the connection speed can be combined to achieve the purpose of link aggregation and increasing the connection speed.

According to another embodiment of the invention, the control unit 14 distributes the packet P appropriately to have the data transmission quantities of the wired network transmission unit 151 and the wireless network transmission unit 152 be substantially the same to reach load balance. In another embodiment, the control unit 14 can distribute the packet P to the wired network transmission unit 151 and the wireless network transmission unit 152 according to a predetermined ratio. For example, the packet P is distributed according to the ratio of the transmission speed of the wired network transmission unit 151 to the transmission speed of the wireless network transmission unit 152. Since transmitting the packet P through the wireless network transmission unit 152 may have the problem of data divulgence, the control unit 14 according to the invention can further encrypt the second packet P2. For example, the wireless encryption protocol (WEP), Wi-Fi protected access (WPA) protocol, WPA2 and so forth can be used in encryption for data divulgence prevention.

In the above mentioned embodiment, the control unit 14 simultaneously combines the wired and wireless transmission units 151 and 152. In another embodiment, the control unit 14 selects either the wired network transmission unit 151 or the wireless network transmission unit 152 as the major transmission unit. For example, since usually the wired network transmission is faster and more stable, the wired network is selected as the major transmission medium and the wireless network is the fail-over system. As the wired network is selected as the major transmission unit, the wireless network becomes the fail-over system. When the wired network is the major transmission medium, if the wired network is disconnected, the control unit 14 detects that the wired network transmission unit 151 cannot transmit the first packet P1 and then converts the format of the first packet P1 into the wireless network format and thereby continues to transmit the packet through the wireless network transmission unit 152. Thus, the network connection does not have transmission disconnection due to the wired network failure. On the contrary, when the wireless network is the major transmission medium, the wired network is the fail-over system. As the wireless network is disconnected, the control unit 14 detects that the wireless network transmission unit 152 cannot transmit the second packet P2 and then converts the format of the second packet P2 into the wired network format and thereby continues to transmit the packet through the wired network transmission unit 151 to provide fail-over.

According to one embodiment of the invention, when the network apparatus 15 transmits a packet to the base station 16 through the wired network transmission unit 151, the network apparatus 15 also receives the data corresponding to the packet from the base station 16 through the wired network transmission unit 151. On the contrary, when the network apparatus 15 transmits a packet to the base station 16 through the wireless network transmission unit 152, the network apparatus 15 also receives the data corresponding to the packet from the base station 16 through the wireless network transmission unit 152. When the network is disconnected, the packet to be originally transmitted/received through the wired/wireless networks will be transmitted/received through the wireless/wired networks, instead. The data transmitting/receiving means of the network apparatus and the base station is not limited to the above examples. Various methods, such as the method according to the state of network transmission or the method according to the preset look up table, can be used. For example, according to the packet transmission speed or bandwidth, the data from the base station 16 is distributed to be transmitted by either the wired network transmission unit 151 or the wireless network transmission unit 152. In one embodiment, as the transmission bandwidth of the wired network exceeds that of the wireless network by a preset value, the wired network transmission unit is used to receive more responded packets within this preset value.

As a user transmits data through the File Transfer Protocol (FTP) or plays online games, the control unit 14 can assign the packet to be transmitted through the wired or wireless network having a more stable or larger bandwidth. For example, when the wired network has larger and more stable bandwidth than the wireless network, the control unit 14 controls the wired network transmission unit 151 to transmit the packet to prevent from unstable transmission. When the wired network is disconnected, the control unit 14 immediately changes to use the wireless network transmission unit 152 to transmit the packet. Thus, the whole efficiency of the network transmission is increased.

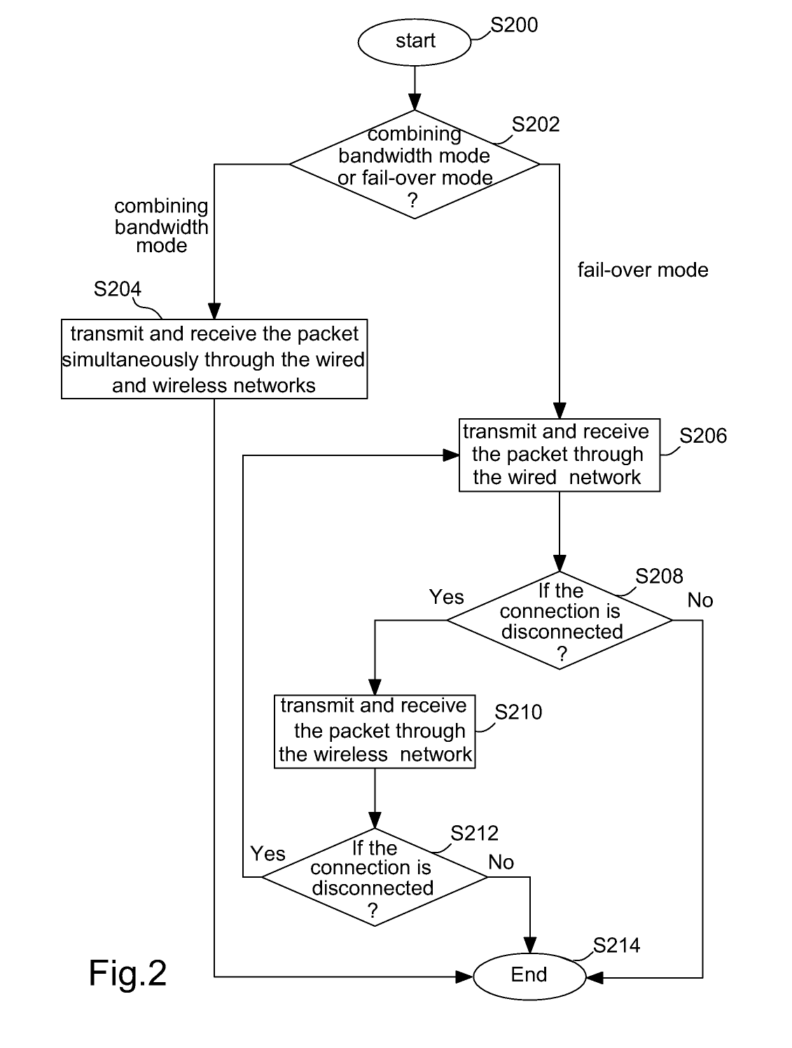

FIG. 2 shows a flow chart illustrating the network transmission method according to one embodiment of the invention. Please also refer to FIG. 1A. After the step S200 starts, go to the step S202 to determine the transmission mode to be either the combining bandwidth mode or the fail-over mode. If it is the combining bandwidth mode, go to the step S204. If it is the fail-over mode, go to the step S206. At first, the combining bandwidth mode is illustrated. After entering the step S204, the packet is transmitted and received simultaneously through the wired and wireless networks to thereby go to the step S214: end.

During the fail-over mode, in the step S206, the control unit mainly selects the wired network to transmit and receive packets. In the step S208, it is determined whether the connection is disconnected or not. If yes, go to the step S210. If not, the transmission is completed to thereby go to the step S214.

If in the step S208 the connection is determined to be disconnected, go to the step S210 to transmit and receive the packet through the wireless network and then go to the step S212 to determined again whether the connection is disconnected or not. If yes, go back to the step S206. If not, the transmission is completed to thereby go to the step S214.

The invention utilizes different transmission media to do integration. For example, the wired and wireless media are used to transmit and receive packets. Thus, the wired network and wireless network coexisting system can have the effect of non-disconnecting transmission and bandwidth combination so as to increase the whole connection speed, effectively utilize the bandwidth, and prevent from inconvenience in network disconnection. Therefore, the purposes of bandwidth combination, having fail-over mechanism, and load balance can be achieved.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. A processing apparatus, comprising:
at least one wired network transmission unit, for transmitting and receiving a first packet through a wired means;
at least one wireless network transmission unit, for transmitting and receiving a second packet through a wireless means; and
a control unit, coupling to the wired network transmission unit and the wireless network transmission unit, for processing and distributing a packet to generate the first packet and the second packet.

2. The apparatus according to claim 1, wherein the control unit comprises an inter media driver for communicating an operating system with the wired network transmission unit and the wireless network transmission unit as a communication medium and processing and distributing the packet.

3. The apparatus according to claim 2, wherein the inter media driver is a communication protocol layer to communicate with the wired network transmission unit and the wireless network transmission unit.

4. The apparatus according to claim 2, wherein the inter media driver is a port to couple with the operating system.

5. The apparatus according to claim 2, wherein the control unit further comprises:
a first network driver interface, through which the inter media driver communicates with the operating system; and
a second network interface, through which the inter media driver communicates with the wired network transmission unit and the wireless network transmission unit.

6. The apparatus according to claim 1, wherein the wired network transmission unit and the wireless network transmission unit simultaneously transmit the first packet and the second packet, respectively.

7. The apparatus according to claim 1, wherein the control unit has the first packet be transmitted through the wireless network transmission unit while the wired network transmission unit has transmission failure.

8. The apparatus according to claim 1, wherein the control unit has the second packet be transmitted through the wired network transmission unit while the wireless network transmission unit has transmission failure or the control unit detects the connection success signal of the wired network transmission unit.

9. The apparatus according to claim 1, wherein the control unit decides to select either the wired network transmission unit or the wireless network transmission unit according to the state of network transmission to transmit the packet.

10. The apparatus according to claim 1, wherein the control unit is a virtual network transmission unit while transmitting data, and the virtual network transmission unit, the wired network transmission unit, and the wireless network transmission unit have the same media access control address.

11. The apparatus according to claim 1, wherein the control unit processes the packet to have the format of the first packet comply with wired network transmission format and to have the format of the second packet comply with wireless network transmission format.

12. The apparatus according to claim 11, wherein the wired network transmission format complies with IEEE 802.3 standard and the wireless network transmission format complies with IEEE 802.11 standard.

13. The apparatus according to claim 1, wherein the control unit encrypts the packet to generate the second packet, the wired network transmission unit is an Ethernet card, or the control unit is implemented by one of the following: software, firmware or hardware.

14. The apparatus according to claim 1, wherein, when the control unit outputs a packet through the wired network transmission unit, the control unit also receives the data corresponding to the packet responded by a base station through the wired network transmission unit.

15. The apparatus according to claim 1, wherein, when the control unit outputs a packet through the wireless network transmission unit, the control unit also receives the data corresponding to the packet responded by a base station through the wireless network transmission unit.

16. The apparatus according to claim 1, wherein the control unit decides how to distribute the packet based on the state of transmission, the data transmission speeds, the data transmission speed ratio, and the bandwidths of the wired network transmission unit and the wireless network transmission unit.

17. The apparatus according to claim 1, wherein the control unit equally distributes the packet to the wired network transmission unit and the wireless network transmission unit to have the wired network transmission unit and the wireless network transmission unit reach load balance.

18. A processing system, comprising:
an operating system, for generating a communication signal and a packet according to a communication protocol while the processing system connects to at least one base station; and
a communication apparatus, for communicating with the operating system and having the functions of wired and wireless networks wherein the communication apparatus decides to simultaneously transmit the packet through the wired network and the wireless network or decides to select either the wired network or the wireless network to transmit the packet according to the communication signal.

19. The system according to claim 18, wherein the communication apparatus comprises an inter media driver for communicating the operating system with the wired network and the wireless network as a communication medium.

20. The system according to claim 18, wherein the wired network and the wireless network have the same media access control address, or the system is a desktop computer or a laptop computer.

21. The system according to claim 18, wherein the communication apparatus selects either the wired network or the wireless network as the major communication medium and the other network as the fail-over system to share the responsibility of the transmission load of the major communication medium while the major communication medium has transmission failure.

22. A transmission method, comprising:
processing a packet to generate a first packet and a second packet; and
providing an inter media driver for deciding how to transmit the first packet and the second packet according to the network state.

23. The method according to claim 22, wherein the step of providing an inter media driver for deciding how to transmit the first packet and the second packet according to the network state comprises:
transmitting the first packet through a wired network; and
transmitting the second packet through a wireless network.

24. The method according to claim 23, further comprising:
transmitting the first packet through the wireless network while the wired network has transmission failure; and
transmitting the second packet through the wired network while the wireless network has transmission failure.

25. The method according to claim 23, wherein the wired network and the wireless network have the same media access control address.
